(19) United States
(12) Patent Application Publication
(10) Pub. No.: US 2023/0148561 A1
(43) Pub. Date: May 18, 2023

(54) APPARATUS AND METHOD FOR LONGITUDINALLY CUTTING A RIBBON OF FOOD, IN PARTICULAR A RIBBON OF CHEESE, INTO STRIPS

(71) Applicant: HOCHLAND SE, HEIMENKIRCH (DE)

(72) Inventor: SEBASTIAN SCHMIDT, ISNY (DE)

(73) Assignee: HOCHLAND SE, HEIMENKIRCH (DE)

(21) Appl. No.: 17/917,243

(22) PCT Filed: Mar. 16, 2021
(86) PCT No.: PCT/EP2021/056608

§ 371 Date: Dec. 15, 2022

(30) Foreign Application Priority Data
Apr. 8, 2020 (DE) 10 2020 109 919.3
Oct. 6, 2020 (DE) 10 2020 126 159.4

(51) Int. Cl. A01J 27/04; B26D 1/36; B26D 1/40

(52) U.S. Cl. CPC A01J 27/04; B26D 1/365; B26D 1/405

(57) ABSTRACT

An apparatus for cutting a ribbon of food into strips. The apparatus includes a cutting apparatus toward which the ribbon of food is moved at a transport speed in a transport direction which has a grooved shaft and a cutting shaft. The grooved shaft has grooves which encircle the grooved shaft in the transport direction. The grooved shaft takes over the ribbon of food. The cutting shaft has cutting knives which encircle the cutting shaft in the transport direction. The cutting shaft is arranged opposite to the grooved shaft. The ribbon of food is guided between the cutting shaft and the grooved shaft. One respective cutting knife engages slightly into one respective groove disposed opposite thereto to cut the ribbon of food into the strips. The cutting shaft has a length of at least 600 mm. The grooved shaft has a length of at least 600 mm.

### CROSS REFERENCE TO PRIOR APPLICATIONS

This application is a U.S. National Phase application under 35 U.S.C. § 371 of International Application No. PCT/EP2021/056608, filed on Mar. 16, 2021 and which claims benefit to German Patent Application No. 10 2020 109 919.3, filed on Apr. 8, 2020, and to German Patent Application No. 10 2020 126 159.4, filed on Oct. 6, 2020. The International Application was published in German on Oct. 14, 2021 as WO 2021/204497 A1 under PCT Article 21(2).

### FIELD

The present invention relates to the technical field of food-processing, in particular the processing of cheese, for producing strips of desired dimensions.

### BACKGROUND

The present invention provides an apparatus and a method which make it possible to produce strips of cheese from a ribbon of cheese. As will be recognized by a person skilled in the art, the present invention is also suitable for the processing of other melted, shapable or softened food products such as, for example, pasta or cold cuts. The apparatus accordingly cuts food products into strips, the products having been shaped in an upstream process to form a continuous ribbon, in particular to form a continuous slab-shaped ribbon of processed cheese. These can in particular be foods that have been produced by an apparatus described in DE 10 328 905 A1. When the term “cheese” is used in the present application, said term represents in principle all types of cheese such as, for instance, pasta filata as an example of natural cheese, processed cheese such as soft cheese, cheese food products, imitation cheese and the like, or plant-based cheese substitutes.

Machines for producing small, separate portions from a larger ribbon of cheese by a series of cutting procedures are well known in the industrial sector. After the actual cheese mass has been produced, it is shaped to form a ribbon of cheese which, usually on a transport belt, is guided to further processing steps. In practice, such a ribbon of cheese is cut into strips in that cutting rollers act on the ribbon of cheese while the ribbon of cheese is guided onward on the transport belt. The knives of the cutting roller in the process likewise act on the transport belt, which can lead to undesirable side effects. Specifically, when the transport belt is produced from a plastics material, this leads to at least small particles of the plastics material coming into contact with the cheese and potentially being absorbed thereby. If the transport belt is produced from metal, this potentially leads to the knives of the cutting roller being rapidly blunted. Such a transport belt also requires active belt feedback-control and in the case of faulty adjustments can easily lead to a back-up of product; complex supporting structures are required in some instances.

DE 696 30 243 T2 describes an apparatus for comminuting cheese without the use of a transport belt, wherein the cheese is cut up by shear forces which are created in that the cheese is guided through two grooved shafts, wherein the grooved shafts are disposed so as to be offset so that the grooved shafts engage flush with one another. It is here disadvantageous that the flush mutual engagement of the grooved shafts as a prerequisite necessitates a complexity in terms of adjustment that is very high and precise, which likewise rendering the disassembly for cleaning very complex. It is furthermore disadvantageous that no smooth cutting edges can be generated as a result of the shear forces, that the cheese is cut up only in a very non-uniform manner, and that the cheese product squeezed into the grooves wraps itself around the grooved shaft, adhering thereto, and leading to contamination.

US 5,129,299 describes a machine for cutting fresh or frozen meats into diced pieces. The machine has a conveying assembly which is composed of an infeed belt and an associated spring-tensioned feed roller, a strip-cutting assembly which is composed of a first knife roller of circular knives, and an associated advancing drum. The advancing drum, while deforming the meat, intensely pushes the meat into the strip-cutting assembly; once the meat has been cut into strips, the meat is supplied to a transverse cutting assembly which is composed of a second knife roller having elongate knives and an associated wiping plate. This wiping plate is provided with a corresponding shearing edge, wherein peripheral portions of the circular knives during transverse cutting engage in comb-type slots in the wiping plate so that the transverse cutting unit can be installed as close to the longitudinal cutting unit as possible. It is here disadvantageous that a wiping plate which is provided with comb-type slots does not have the stiffness required to achieve fine cutting widths, in particular in the case of large widths. Comb-type slots in the wiping plate are also not desirable for hygienic reasons because the trapping of comparatively small remnants of meat in the slots must be avoided, requiring the comb-type slots to be regularly cleaned.

The current situation is thus that either the cutting must be carried out by a transport belt in order to obtain the pieces in a defined shape, or else a transport belt can be dispensed with, whereby the cheese pieces in this case do not have appealing cutting edges and appear somewhat misshapen.

### SUMMARY

An aspect of the present invention to provide an apparatus for longitudinal cutting, a compact system for longitudinal and transverse cutting, and a method which makes possible improved the cutting of a ribbon of cheese into longitudinal strips and/or cubes, so as to eliminate at least in part the disadvantages of the prior art mentioned above.

In an embodiment, the present invention provides an apparatus for longitudinally cutting a ribbon of food, such as a ribbon of cheese, into strips. The apparatus includes a longitudinal cutting apparatus toward which the ribbon of food is moved at a transport speed in a transport direction. The longitudinal cutting apparatus includes a grooved shaft and a cutting shaft. The grooved shaft has a grooved shaft axis which is disposed transversely to the transport direction and a plurality of grooves which encircle the grooved shaft in the transport direction of the ribbon of food. The grooved shaft is configured take over the ribbon of food as it is moved toward the grooved shaft. The cutting shaft has a cutting shaft axis which is disposed transversely to the transport direction and a plurality of cutting knives which encircle the cutting shaft in the transport direction of the ribbon of food. The cutting shaft is disposed opposite to the grooved shaft. The ribbon of food is guided between the cutting shaft and the grooved shaft. One respective cutting knife of the plurality of cutting knives engages slightly into one respective groove of the plurality of grooves disposed opposite thereto so that the ribbon of food is cut into strips along the transport direction. The cutting shaft has a length of at least 600 mm along the cutting shaft axis. The grooved shaft has a length of at least 600 mm along the grooved shaft axis.

### BRIEF DESCRIPTION OF THE DRAWINGS

The present invention is described in greater detail below on the basis of embodiments and of the drawings in which:

FIG. 1 shows a perspective view of a grooved shaft;

FIG. 2 shows a perspective view of a cutting shaft;

FIG. 3 shows a cross section of a longitudinal cutting apparatus according to the present invention in the transport direction of a ribbon of cheese;

FIG. 4 shows a lateral view of the longitudinal cutting apparatus according to the present invention from FIG. 3; and

FIG. 5 shows an upgrade of the longitudinal cutting apparatus from FIG. 3 and FIG. 4 in the form of a transverse cutting apparatus.

### DETAILED DESCRIPTION

A first aspect of the present invention is an apparatus for cutting a ribbon of food, in particular for longitudinally cutting a ribbon of cheese, into strips, wherein the apparatus has a longitudinal cutting apparatus toward which the ribbon of food is moved at a transport speed in a transport direction, wherein the longitudinal cutting apparatus comprises:
a grooved shaft having a grooved shaft axis which is disposed transversely to the transport direction, wherein a multiplicity of grooves encircle the grooved shaft in the transport direction of the ribbon of food, wherein the grooved shaft is specified for taking over the ribbon of food moved toward the latter; and
a cutting shaft having a cutting shaft axis which is disposed transversely to the transport direction, wherein a multiplicity of cutting knives encircle the cutting shaft in the transport direction of the ribbon of food.

The core concept of the present invention here is that the cutting shaft is disposed opposite to the grooved shaft, the ribbon of food is guided between the cutting shaft and the grooved shaft, and that a cutting knife engages in each case slightly in an opposite groove so that the ribbon of food along the transport direction is cut into strips.

This has the advantage that a transport belt on which the ribbon of cheese is cut can be dispensed with, while the ribbon of cheese is nevertheless cut into defined strips, because the cutting knives have a sharp blade and cut the ribbon of the cheese, instead of squashing the ribbon of cheese by means of “shear forces” as in the prior art. Further advantages are derived in that the cutting knives engage only slightly in the opposite groove. It is thereby achieved that the cheese mass is not squeezed into the corresponding groove to an unnecessary depth, so that contamination of the grooved shaft is prevented, wherein a further advantage is derived in that slightly bent knives are still spaced apart from the walls that configure the respective grooves. The dimension of the cutting knives is thus chosen in an optimized manner so that it is still provided, even in the case of bent cutting knives, that the ribbon of cheese is completely cut, and it is prevented that the cutting knives, when bent in such a way, do not impact the walls of the corresponding grooves. It has here proven advantageous for the dimension of the cutting knives to be selected so that each cutting knife protrudes into the opposite groove by 1 mm, or, for example, by 0.5 mm. The extent to which the cutting knives protrude into the opposite groove is steplessly adjustable between the aforementioned values. This apparatus also enables a very compact construction mode which can also be transported in a portable manner. It is advantageous for the grooves to have a greater width than depth due to facilitate cleaning.

The cutting shaft along the cutting shaft axis thereof, and the grooved shaft along the grooved shaft axis thereof, can, for example, in each case have a length of at least 600 mm. This has the advantage that ribbons of cheese with great width can be very efficiently processed in order for the overall throughput of the cheese production to be increased. The value of 600 mm is also adapted to customary machines which can provide such ribbons of cheese, for example, also in a continuous manner. Particular reference here is made to the FreeSlice^{®} 800 machine. The cutting shaft along the cutting shaft axis thereof, and the grooved shaft along the grooved shaft axis thereof, can, for example, in each case have a length of at least 1100 mm. The overall turnover can thereby be increased yet again, whereby the value of 1100 mm is adapted to the so-called FreeSlice^{®} 1500 machine. Such large widths of the ribbon of cheese cannot be processed using customary cutting systems which have a comb for wiping the cheese during the cutting procedure, because a comb of this length for reasons of material technology does not have the necessary stiffness in order to be able to cut the ribbon of cheese in many thin strips.

A groove width can, for example, be at least double the size of a knife thickness. The groove width as well as the knife thickness is to be understood to be the respective extent in the direction of the corresponding axis, thus of the grooved shaft axis or of the cutting shaft axis, respectively. As a result of the knife thickness thus being designed to be significantly thinner than the groove width, it is possible for a sharp cut, in particular a longitudinal cut, to be generated in the ribbon of cheese. A groove width of 1.5 mm to 2 mm can, for example, be used. A groove height of 1.25 mm has moreover proven to be favorable.

The grooves can, for example, have a mutual spacing of at least 3.6 mm. It is derived therefrom that the mutual spacing of the grooves is approximately double the groove width. As a result of this ratio, it is provided that the ribbon of cheese can bear uniformly on the grooved shaft. The cutting knife can, for example, have a thickness of 0.3 mm to 0.8 mm.

In the case of these dimensions, it is likewise advantageously provided that the cutting knives, even when slightly bent, do not impact the walls of the grooves and, as a result, are blunted or block the apparatus. A certain tolerance range is moreover achieved for the adjustment. Specifically, when all cutting knives are dimensioned, for example, to be somewhat thicker than required, this has a cumulative effect, or leads to irregularities when the cutting knives are introduced into the grooves during adjustment. However, if the grooved shafts of this embodiment are configured to be at least double the size of the knife thicknesses, as described, these irregularities can be absorbed as a result. A further possibility of equalizing these irregularities lies in fitting compensation rings between the cutting knives. These compensation rings can likewise be pushed onto the cutting shaft and can, for example, be composed of a stainless steel body and may be coated with silicone for sealing purposes.

In one embodiment, the apparatus has a first drive unit, wherein the first drive unit is specified for driving the grooved shaft at least at the transport speed. This means that a rotating speed of the ball-bearing mounted grooved shaft is thus adjusted so that the external circumference of the grooved shaft, and thus the surface of the grooved slot, moves at the transport speed in the transport direction. This offers the advantage that the ribbon of cheese does not back up when the ribbon of cheese is taken over by the grooved shaft. If the grooved shaft is driven by a transport speed that is higher than the transport speed of the ribbon of cheese, the ribbon of cheese is slightly stretched as a result and placed under tension, which may prove advantageous for the following longitudinal cutting procedure. The drive unit here can be adjusted so that the grooved shaft rotates at 1.01 to 1.05 times the transport speed. Another factor may prove to be particularly favorable depending on the type of cheese or the thickness of the ribbon of cheese.

In one advantageous design embodiment, a plurality of cutting teeth are configured on the external circumference of the cutting knives. The cutting knives in this instance perform the actual cutting procedure and are also the elements that engage in the grooves. The number of cutting teeth that may be configured on the external circumference of the cutting knife is flexible, whereby a number of three cutting teeth has proven to be particularly advantageous. The use of cutting teeth has the advantage that the contact face of the ribbon of cheese with the cutting knife is reduced, and, as a result, an undesirable adhesive effect between the ribbon of cheese and the cutting knife is reduced.

Mutually opposite cutting knives can, for example, be disposed to be rotated so that the respective cutting teeth are disposed to be offset in the direction of the cutting shaft axis. The cutting teeth of adjacent cutting knives thus do not obscure one another in the direction of the cutting shaft axis. This means that a specific location along the ribbon of cheese is not longitudinally cut by two sides simultaneously, but is at all times in contact only with the cutting teeth on the left side of the ribbon of cheese or in contact with the cutting teeth on the right side of the ribbon of cheese. This in turn has the advantage that an undesirable adhesive effect between the ribbon of cheese and the cutting knives is reduced.

The apparatus can have a second drive unit, wherein the second drive unit is specified for driving the cutting shaft. The rotating speed of the cutting shaft is here specified so that the plurality of cutting teeth generate a continuous cut in the ribbon of food. In other words, this means that a subsequent cutting tooth engages in the slot in the ribbon of cheese that has been produced by the preceding cutting tooth. It has here proven advantageous for the cutting shaft to rotate at a rotational speed, so that the revolving speed of the cutting teeth corresponds to 7 to 10 times the transport speed. A smooth continuous cutting edge can thereby advantageously be generated in the ribbon of cheese.

In one embodiment of the apparatus, the spacing of the cutting knives corresponds to a multiple of the spacing of the grooves. As has already been explained above, the mutual spacing of the respective groove centers can be 3.6 mm. As has already been mentioned in this context, the correct ratio between the groove centers and the groove width is important. The feature of the spacing of the cutting knives corresponding to a multiple of the spacing of the grooves in any case advantageously enables that longitudinal strips of different widths can be generated. If the spacing of the adjacent cutting knives is 3.6 mm and the mutual spacing of the grooves is likewise 3.6 mm, longitudinal strips of a width of approximately 3.6 mm are thus likewise generated. However, if the spacing of the adjacent cutting knives is 7.2 mm, the knives in this case engage only in every other groove and a longitudinal strip of the ribbon of cheese of a width of approximately 7.2 mm is generated. As a result, it is thus made possible that different widths of longitudinal strips can be flexibly generated, even in a single longitudinal cutting procedure. The only prerequisite is that the cutting knives are correspondingly disposed. Since the grooved shaft can remain unaltered in the process, this offers an efficient possibility of flexibly designing the shape of the pieces of cheese.

The cutting shaft can, for example, be disposed opposite to the center of the circumference of that segment of the grooved shaft that is impinged by the ribbon of food. In other words, if an imaginary perpendicular to the grooved shaft axis extends parallel to the transport direction of the ribbon of cheese, the cutting shaft in this instance is disposed opposite to the grooved shaft so that the cutting shaft is oriented at an angle of -45° in relation to the perpendicular. Experiments have demonstrated that the ribbon of cheese in this position bears advantageously on the grooved shaft, for example, because the ribbon of cheese (as a result of the already cut strips of the ribbon of cheese suspended from the grooved shaft) is correspondingly tensioned so that the best cutting results have been achieved. Variations of this angle of up to 15° will still deliver an acceptable cutting result.

A second aspect of the present invention is a method for cutting a ribbon of food using the above apparatus, in particular for longitudinally cutting a ribbon of cheese into strips, wherein the method comprises the following steps:
moving a ribbon of food at a transport speed toward the longitudinal cutting apparatus;
handing over the ribbon of food to the grooved shaft of the cutting apparatus, wherein the circumference of the grooved shaft in the transport direction rotates at least at the transport speed, and the grooved shaft on the surface thereof guides the ribbon of food in the direction of a cutting shaft, wherein the cutting shaft is disposed opposite to the grooved shaft and, as a result, the ribbon of food is guided through between the grooved shaft and the cutting shaft;
wherein a cutting knife of the cutting shaft engages in each case slightly in an opposite groove and, as a result, the ribbon of food along the transport direction is cut into strips.

A third aspect of the present invention is a testing method for determining an optimized apparatus described above for cutting a ribbon of food, in particular a ribbon of cheese, wherein the grooved shaft in the direction of the grooved shaft axis thereof has a plurality of zones, wherein dimensions of the grooves in one of the zones differ from the dimensions of the grooves in one of the other zones.

Since the ribbon of cheese, or the ribbon of food, respectively, is a product with variable characteristics (based already on the reason that the “raw material” in certain circumstances may be highly variable in terms of the quality thereof), it cannot be provided that the ribbon of cheese in different experimental procedures for determining an optimum width, or an optimum spacing of the grooves, respectively, will always have the same characteristics. It may be the case, for example, that the ribbon of cheese in one instance has a higher water content than in another. This can falsify the measured results via which it is established which dimensions of the grooves are the most advantageous. As a result of different dimensions of the grooves being verified quasi-simultaneously on a ribbon of cheese in the method according to the present invention, these uncertainties in the valuation can be reduced, and the optimum spacing, or the optimum dimensions, of the grooves can be reliably concluded, respectively.

A fourth aspect of the present invention is a system for longitudinally and transversely cutting a ribbon of food, in particular a ribbon of cheese, into pieces. The system has:

a longitudinal cutting apparatus toward which the ribbon of food is moved at a transport speed in a transport direction, wherein the longitudinal cutting apparatus comprises:
a grooved shaft having a grooved shaft axis disposed transversely to the transport direction, wherein a multiplicity of grooves encircle the grooved shaft in the transport direction of the ribbon of food, wherein the grooved shaft is specified for taking over the ribbon of food moved toward the latter;
a cutting shaft having a cutting shaft axis disposed transversely to the transport direction, wherein a multiplicity of cutting knives encircle the cutting shaft in the transport direction of the ribbon of food;
wherein the cutting shaft is disposed opposite to the grooved shaft, and the ribbon of food is guided between the cutting shaft and the grooved shaft, wherein a cutting knife engages in each case slightly in an opposite groove and, as a result, the ribbon of food along the transport direction is cut into strips;
a transverse cutting unit to which the ribbon of food cut into strips is transferred for transverse cutting into pieces, in particular into cuboid pieces, wherein the longitudinal cutting apparatus comprises:
a transverse cutting shaft having a transverse cutting unit axis, wherein the transverse cutting unit axis can, for example, be attached so as to be parallel to the grooved shaft axis, wherein at least one knife blade is attached to the transverse cutting shaft and rotates about the transverse cutting unit axis, wherein the transverse cutting unit, by the rotating movement of the at least one knife blade, is configured for transversely cutting the longitudinal strips into pieces;
wherein the transverse cutting unit axis in the vertical direction is disposed below the grooved shaft axis and below the cutting shaft axis, and wherein the transverse cutting unit axis in the horizontal direction is disposed between the grooved shaft axis and the cutting shaft axis.

This enables a very compact construction mode, in particular in terms of a base area of the system. An additional transport belt between the transverse cutting unit and the longitudinal cutting apparatus can advantageously be dispensed with because the longitudinal strips are “transported” from the longitudinal cutting apparatus to the transverse cutting unit by gravity, so to speak.

Exemplary embodiments of the present invention will be explained below under reference to the drawings. The present disclosure is not limited to the specifically mentioned combinations of features. The features mentioned here can much rather be combined in an arbitrary manner so as to form embodiments according to the present invention, unless explicitly precluded.

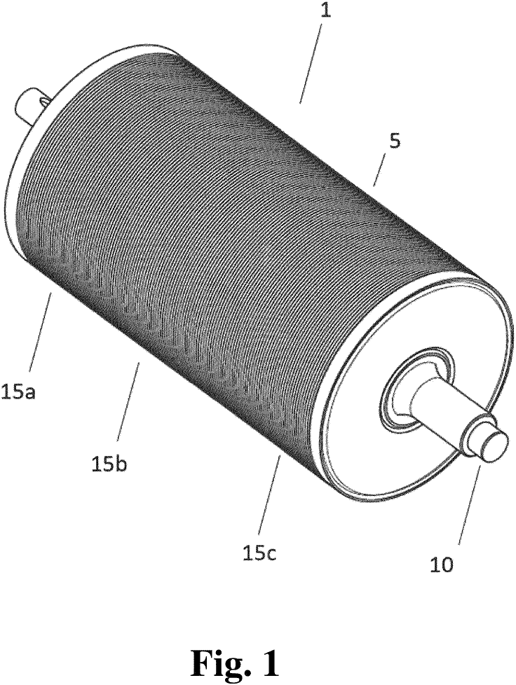

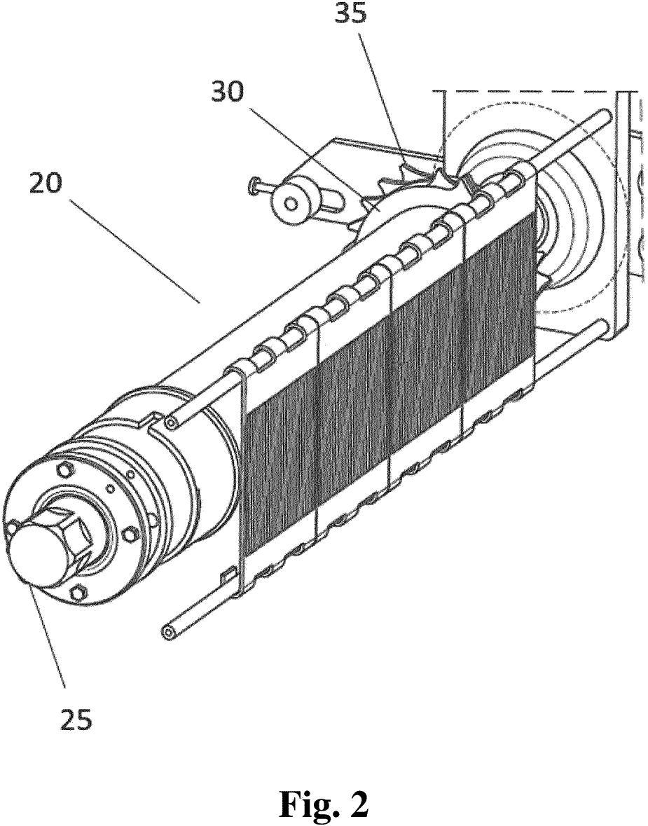

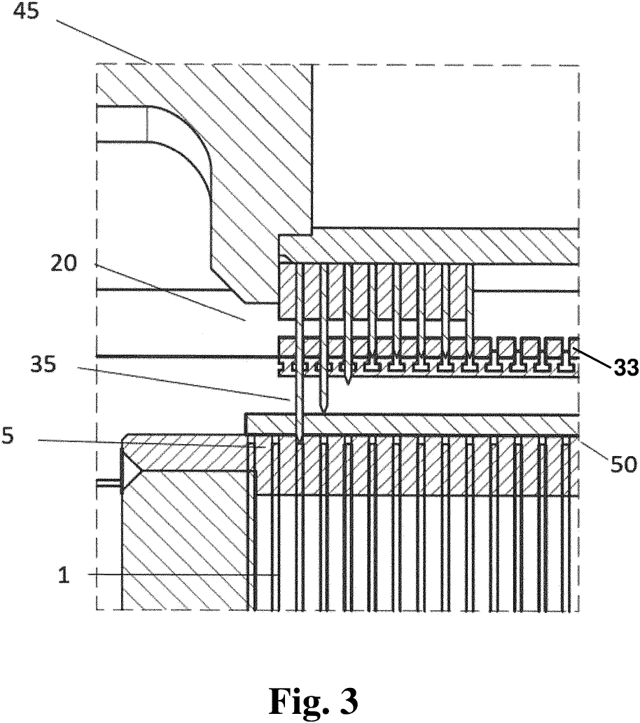

FIG. 1 shows a grooved shaft which interacts with the cutting shaft 20 from FIG. 2 so as to conjointly configure the longitudinal cutting apparatus 45 according to the present invention and according to FIG. 3.

The grooved shaft 1 is configured so as to be substantially cylindrical, wherein the circumference of the cylinder external surface is encircled by grooves 5. The grooved shaft 1 is installed so as to be mounted by ball bearings in the longitudinal cutting apparatus 45 according to FIG. 3, is driven by a first motor and rotates about the grooved shaft axis 10. A grooved shaft 1 which displays three different zones with different groove profiles 15a, 15b, 15c is presently depicted. However, the different groove profiles 15a, 15b, 15c are so similar that they cannot be visually differentiated in FIG. 1. Such a grooved shaft 1 can, for example, be used for the testing method according to the present invention so as to be able to establish which groove profile is particularly suitable for industrial use. Since a ribbon of cheese in particular is a “live” product which has different characteristic parameters in each batch, it would be potentially insignificant to carry out different test runs having in each case different grooved shafts 1, the latter however all having one identical groove profile 1. As a result of the test runs being carried out using a grooved shaft 1 according to FIG. 1, the uncertainty which is created by virtue of the different characteristics of the ribbon of cheese can be significantly reduced. In the later use in the production of cheese, however, a grooved shaft 1 which has only a single “homogenous” groove profile 15 can, for example, be used. The latter being specifically that groove profile 15 that in the testing method according to the present invention has proven to be best suited to a specific variety of cheese.

The testing method has demonstrated that it is advantageous for most ribbons of cheese that the width of the grooves is 1 mm to 2 mm, the depth of the grooves is approximately 1 mm, and the grooves have in each case a respective center spacing of 3.6 mm. The base of the groove profiles 15 can be configured so as to be planar or else semicircular. The base of the groove profiles 15 can, for example, however, be configured to be semicircular because fewer “edges” are created as a result on which the cheese mass can settle. “Round structures” are typically easier to clean. Parameters of this magnitude of the groove profile 15 lead to the ribbon of cheese being able to be guided smoothly and reliably, without sagging, on the grooved shaft 1 and a longitudinal cut of good quality being able to be simultaneously performed.

FIG. 2 shows a perspective view of the cutting shaft 20. The cutting shaft 20 is likewise installed so as to be mounted by ball bearings in the longitudinal cutting apparatus 45, is driven by a second motor and rotates about the cutting shaft axis 25 of the cutting shaft 20. The cutting shaft 20 is likewise configured so as to be cylindrical, wherein cutting knives 30 are attached along the cutting shaft axis 25 of the cutting shaft 20. The cutting knives in the cutting blade thereof can, for example, have a circular recess, wherein the internal radius of this circular recess corresponds to the external radius of the cutting shaft 20. This makes it possible for the cutting knives 30 to be able to be pushed onto the cutting shaft 20 in the direction of the cutting shaft axis 25 and, as a result, in the direction of the cutting shaft axis 25 to be able to extend across a cutting width provided and established for the ribbon of cheese. The cutting knives 30 can be fixed to the cutting shaft 20 in a rotationally fixed manner, for example, by screw-fitting.

The cutting knives 30 can be configured as circular knives having a constant external radius of the cutting face, or having cutting teeth 35, as in FIG. 2. These cutting teeth 35 project from the cutting knife 30 along the circular circumference of the latter and cut into the ribbon of cheese. The variant having the cutting teeth 35 is advantageous when the friction between the cheese mass and the cutting knife 30 is to be reduced, because a contact face between the ribbon of cheese and the cutting knife 30 is in this case smaller. Adjacent cutting knives 30, thus cutting knives 30 which are successive in the direction of the cutting shaft axis 25, are here disposed so as to be rotated on the cutting shaft 20 so that the respective cutting teeth 35 do not obscure one another. In other words, if a straight line, parallel to the cutting shaft axis 25 is drawn through a cutting tooth 35, this straight line must not meet a cutting tooth 35 of the adjacent cutting knife 30. This rotation likewise reduces the contact face between a specific location of the ribbon of cheese and the cutting knives 30.

Dimensions of the ribbon of cheese 50 can, for example, include a length of at least 2 m, a width of at least 650 mm, and a thickness of at most 15 mm. A ribbon of cheese 50 having these dimensions is very sensitive to impingements with force so that the method steps of transporting as well as the method steps of longitudinal and/or transverse cutting must take particular care in this respect. A so-called “continuous” ribbon of cheese 50 can alternatively also be used, the production being even more effective as a result.

A height of the cutting knives 35, or the portion of the cutting knife having the sharp blade 95, is adapted to the thickness of the cheese; the height of the cutting knife can, for example, be slightly higher than the thickness of the ribbon of cheese so that the ribbon of cheese can be completely cut, but is also as minor as possible so as to prevent a bending of the knives, keep material costs low, and to be able to construct the plant to be as compact as possible. In the case of a thickness of the ribbon of cheese 50 of at most 15 mm, the height of the cutting knives can, for example, be at most 25 mm. In the case of the thickness of the ribbon of cheese of at most 10 mm, the height of the cutting knives can, for example, be at most 20 mm.

FIG. 3 shows a cross section of the longitudinal cutting apparatus 45 according to the present invention in the transport direction of a ribbon of cheese 50, wherein the ribbon of cheese 50 is guided through between the cutting shaft 20 and the grooved shaft 1. The longitudinal cutting apparatus 45 comprises the cutting shaft 20 and the grooved shaft 1, which are disposed so as to be mutually opposite, wherein the grooved shaft axis 10 and the cutting shaft axis 25 are disposed so as to be mutually parallel. A ribbon of cheese 50 here bears on the grooved shaft 1 and is held on the grooved shaft 1 by gravity. The cutting shaft 20 is consequently provided above the grooved shaft, or obliquely opposite to the grooved shaft. FIG. 3 in an exemplary manner shows a cutting shaft 20 which is not completely populated with cutting knives 30, this only being intended to visualize the principle.

The cutting knives 30 are disposed so as to be rotationally fixed on the cutting shaft 20, wherein correspondingly designed spacers 33 between the cutting knives are provided in this instance so that each cutting tooth 35 can engage in a groove 5 of the grooved shaft 1. The size of the spacers 33 is thus derived from the spacing of the grooves 5 along the grooved shaft axis 10. It is particularly advantageous for the cutting tooth 35 to only engage slightly in the groove 5 opposite thereto, as is shown in FIG. 3. A slight engagement of the cutting tooth 35 provides that the ribbon of cheese 50 is completely severed and simultaneously reduces the probability of the cutting tooth 35 contacting the walls of the groove 5. Such contact can lead to the cutting teeth 35 being rapidly blunted. It has been demonstrated to be advantageous for a cutting tooth 35 to engage in the groove 5 provided therefor to a depth of approximately 0.5 mm.

The cutting knives 30, or the cutting teeth 35, respectively, are also designed having a thickness of 0.3 mm to 0.8 mm, the latter being minor in comparison to the width of the grooves of 1.5 mm to 2 mm. This provides a clean, thin cut, and provides that the cutting teeth 35 will still reliably engage in the corresponding grooves 5 when variations in the thickness of the spacers 40, of the cutting knives 30, or of other components arise, for example, owing to production tolerances. If the thickness of the cutting teeth 35 were to be only slightly different than the width of the grooves, a somewhat excessively thick spacer 40 in this instance would lead to the cutting tooth 35 bearing on the surface of the grooved shaft 1 between the respective grooves 5. This would immediately bend the cutting tooth 35, potentially destroy the cutting tooth 35, and block the machine.

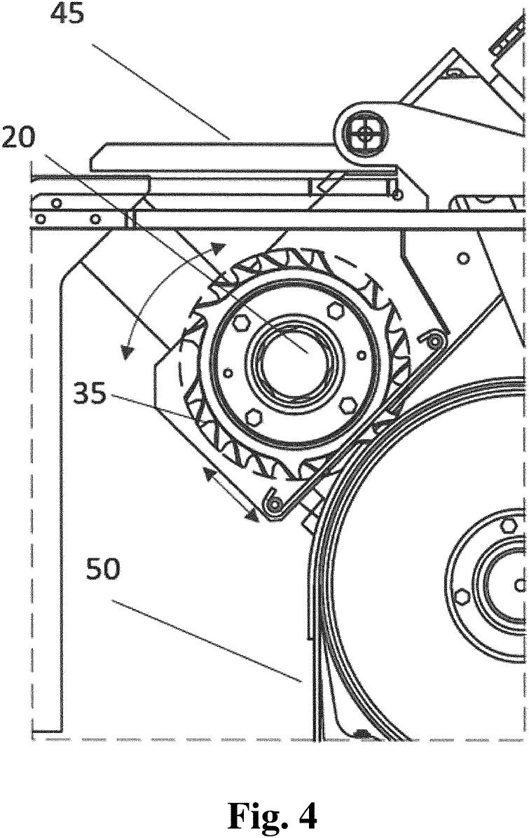

FIG. 4 shows a lateral view of the longitudinal cutting apparatus according to the present invention from FIG. 3. The grooved shaft 1 and the cutting shaft 20 are attached so as to be opposite one another so that the grooved shaft axis 10 and the cutting shaft axis 25 are aligned so as to be mutually parallel. The cutting shaft 20 is disposed so as to be oblique above the grooved shaft 1, for example, at an angle of 45% in relation thereto. As a result of this arrangement, the longitudinal cut performed by the cutting teeth 35 takes place at a position of the ribbon of cheese 50 at which the ribbon of cheese 50 is slightly stretched by the strips of cheese already hanging down in the transport direction. This slight elongation leads to a better longitudinal cutting result. The cutting shaft 20 is, however, pivotable in relation to the plane of the transport direction of the cheese by an angle of 0 to 45 degrees (the assembly is thus to be rotatable by approximately 20 degrees in the counterclockwise or in the clockwise direction, respectively), and/or is height adjustable from -3 mm to 20 mm. This makes it possible that the cutting shaft 20 for cleaning can be easily pivoted upward from the ribbon of cheese and that the cutting teeth 35 for optimized longitudinal cutting of the ribbon of cheese 50 can be adjusted to be adapted to the type of cheese.

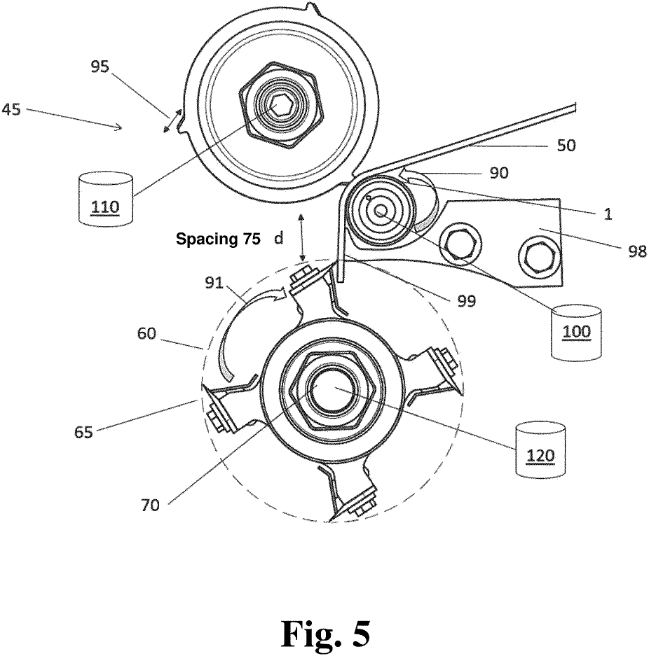

Such controlled discharging of the ribbon of cheese 50 cut into longitudinal strips is particularly advantageous when, after the procedure of longitudinal cutting, a transverse cutting unit 60 is additionally provided, as is shown in a lateral view in FIG. 5, wherein the longitudinal cutting apparatus and the transverse cutting unit 60, as a result of this particular arrangement, conjointly configure a very compact system for longitudinal and transverse cutting. FIG. 5 shows how the longitudinal strips hang down from the grooved shaft 1 and into the transverse cutting unit 60, and are cut into cheese cubes thereby. A compact construction mode, in particular in terms of a base area of the system for longitudinal and transverse cutting, is enabled in that the longitudinal strips hang down from the grooved shaft 1 and are fed to the transverse cutting unit 60 in a quasi-automatic manner by gravity. Compact dimensions in terms of the base area are particularly advantageous for such a system because it is the base area, and not the height of production buildings, that in most instances represents a limiting factor. In that the transverse cutting unit 60 is thus disposed under the longitudinal cutting apparatus, a transport belt which feeds the longitudinal strips to the transverse cutting unit 60 can be dispensed with.

The transverse cutting unit 60 in the horizontal direction is disposed so that the axis thereof, the transverse cutting unit axis 70, is between the cutting shaft axis 25 and the grooved shaft axis 10. The transverse cutting unit axis 70 in the vertical direction is provided below the grooved shaft axis 10.

In order to be able to provide the system to be as flexible as possible and to be rapidly adjusted, the grooved shaft 1 is driven by a first drive unit 100, the cutting shaft 20 is driven by a second drive unit 110, and the transverse cutting unit is driven by a third drive unit 120. The rotational speed of the transverse cutting unit 60, which is established by the third drive unit 120, substantially establishes the final length of the cheese strips after transverse cutting. The faster the transverse cutting unit 60 rotates, the shorter the final cheese strips. As a result of a suitable interaction between the transport speed of the ribbon of cheese and the rotating speed of the transverse cutting unit 60, an arbitrary length of cheese strips can be in principle generated.

The transverse cutting unit 60 for transversely cutting the longitudinal strips comprises on a cutting-edge 99 of a counter-knife 98, for example, four knife blades 65 which are disposed so as to be perpendicular to the transport direction and rotate about a transverse cutting unit axis 70, wherein the transverse cutting unit axis 70 is disposed along the plane that is defined by the suspended longitudinal strips of the ribbon of cheese 50. In principle, it is possible to provide 1 to 8 knife blades, depending on the transport speed of the ribbon of cheese. The objective here is to keep the cutting speed approximately constant, depending on the transport speed of the ribbon of cheese. In the case of excessively low cutting speeds, this results in the problem that the longitudinal strips are not completely cut, this leading to a “formation of flags”. In the case of excessively high cutting speeds, this results in the problem that the higher rotating speeds reduce the service life of mountings and that the entire plant must be constructed to be stiffer or stronger, respectively.

In terms of the vertical dimensions, the system becomes more compact in that the counter-knife 98 is provided directly below the grooved shaft 1, and in particular the portion of the counter-knife 98 that faces the longitudinal strips, by way of the cutting edge 99 on the side thereof that faces the grooved shaft 1, at least in portions imitates the external shape of the grooved shaft 1. In that the portion of the counter-knife 98 by way of the cutting edge 99 thus quasi-surrounds the grooved shaft 1, a compact vertical construction mode is provided and the suspended longitudinal strips can be stabilized and guided. The cutting edge 99 on which the knives sever the longitudinal strips is provided on that side of the counter-knife 98 that faces away from the grooved shaft 1. The longitudinal strips can, for example, contact the counter-knife 98 only on the cutting edge 99. If a perpendicular tangent is placed on the grooved shaft 1, the cutting edge is thus provided along this tangent.

FIG. 5 moreover illustrates that the rotating direction 90 of the grooved shaft 1 and the rotating direction 91 of the transverse cutting unit 60 are opposed. In the arrangement of the system according to FIG. 5, this makes it possible that the longitudinal strips in the transverse cutting procedure can be “transversely” cut almost without vibrations. The rotating direction 90 of the grooved shaft 1 presently is counterclockwise, and the rotating direction 91 of the transverse cutting unit 60 is clockwise.

The diameter of the grooved shaft 1 influences the spacing d 75, the latter characterizing how far the longitudinal strips hang down from the grooved shaft 1 until the longitudinal strips contact the knife blades 65 of the transverse cutting unit 60. The diameter of the grooved shaft 1 is a function of the width of the ribbon of cheese 50. The wider the design of the ribbon of cheese, the larger a selected diameter of the grooved shaft 1, so as to prevent flexing of the grooved shaft 1. If the spacing d 75 is excessive, this can lead to the longitudinal strips excessively “swinging” and the transverse cutting procedure not being able to be optimally carried out as a result. It applies in principle that the smaller the configuration of the grooved shaft 1, the smaller the selected spacing d 75. This also makes possible a more compact construction mode of the entire apparatus. The test measurements have demonstrated that the diameter of the grooved shaft 1 is advantageously between 40 mm and 300 mm.

The present invention thus enables a compact arrangement of a longitudinal cutting shaft and a transverse cutting shaft when a ribbon of cheese is to be cut into cheese cubes. The previously known transport belt, including a knife edge deflection ahead of the counter-knife, can be dispensed with. The apparatus described is also very well suited to CIP (cleaning in place). Contaminations with the product by the transport belt, as in the conventional cutting procedure, are prevented.

The present invention is not limited to embodiments described herein; reference should be had to the appended claims.

LIST OF REFERENCE NUMERALS

| | |
|---|---|
| 1 | Grooved shaft |
| 5 | Grooves |
| 10 | Grooved shaft axis |
| 15a-c | Groove profile |
| 20 | Cutting shaft |
| 25 | Cutting shaft axis |
| 30 | Cutting knives/cutting knife |
| 33 | Spacer |
| 35 | Cutting teeth/cutting tooth |
| 45 | Longitudinal cutting apparatus |
| 50 | Ribbon of cheese |
| 60 | Transverse cutting unit |
| 65 | Knife blade |
| 70 | Transverse cutting unit axis |
| 75 | Spacing d |
| 90 | Rotating direction (of grooved shaft 1) |
| 91 | Rotating direction (of transverse cutting unit 60) |
| 95 | Sharp blade |
| 98 | Counter-knife |
| 99 | Cutting edge |
| 100 | First drive unit |
| 110 | Second drive unit |
| 120 | Third drive unit |

1-11. (canceled)

12. An apparatus for longitudinally cutting a ribbon of food, such as a ribbon of cheese, into strips, the apparatus comprising a longitudinal cutting apparatus toward which the ribbon of food is moved at a transport speed in a transport direction, the longitudinal cutting apparatus comprising:
a grooved shaft comprising a grooved shaft axis which is disposed transversely to the transport direction and a plurality of grooves which encircle the grooved shaft in the transport direction of the ribbon of food, the grooved shaft being configured take over the ribbon of food as it is moved toward the grooved shaft; and
a cutting shaft comprising a cutting shaft axis which is disposed transversely to the transport direction and a plurality of cutting knives which encircle the cutting shaft in the transport direction of the ribbon of food,
wherein,
the cutting shaft is disposed opposite to the grooved shaft,
the ribbon of food is guided between the cutting shaft and the grooved shaft,
one respective cutting knife of the plurality of cutting knives engages slightly into one respective groove of the plurality of grooves disposed opposite thereto so that the ribbon of food is cut into the strips along the transport direction,
the cutting shaft has a length of at least 600 mm along the cutting shaft axis, and
the grooved shaft has a length of at least 600 mm along the grooved shaft axis.

13. The apparatus as recited in claim 12, wherein,
each of the plurality of grooves has a groove width,
each of the plurality of cutting knives has a cutting knife thickness, and
the groove width is at least 1.5 times the cutting knife thickness.

14. The apparatus as recited in claim 12, further comprising:
a first drive unit which is configured to drive the grooved shaft at least at the transport speed.

15. The apparatus as recited in claim 14, further comprising:
a second drive unit which is configured to drive the cutting shaft,
wherein,
a rotating speed of the cutting shaft is set so that the plurality of cutting teeth generate a continuous cut in the ribbon of food.

16. The apparatus as recited in claim 12, wherein the plurality of cutting knives comprise a plurality of cutting teeth which are arranged on an external circumference of the plurality of cutting knives.

17. The apparatus as recited in claim 16, wherein mutually opposite cutting knives of the plurality of cutting knives are rotatably disposed so that the respective cutting teeth of the plurality of cutting teeth are offset in a direction of the cutting shaft axis.

18. The apparatus as recited in in claim 12, wherein a spacing of the plurality of cutting knives corresponds to a multiple of a spacing of the plurality of grooves.

19. The apparatus as recited in in claim 12, wherein,
a center of a circumference of a segment of the grooved shaft is impinged by the ribbon of food, and
the cutting shaft is disposed opposite to the center of the circumference of the segment of the grooved shaft that is impinged by the ribbon of food.

20. A method for cutting a ribbon of food using the apparatus as recited in claim 12, such as for longitudinally cutting a ribbon of cheese into strips, the method comprising:
moving the ribbon of food at a transport speed toward the longitudinal cutting apparatus; and
handing over the ribbon of food to the grooved shaft of the cutting apparatus,
wherein,
a circumference of the grooved shaft in a transport direction rotates at least at the transport speed,
a surface of the grooved shaft guides the ribbon of food in a direction of the cutting shaft, and
the cutting shaft is disposed opposite to the grooved shaft so that the ribbon of food is guided between the grooved shaft and the cutting shaft,
wherein,
one respective cutting knife of the plurality of cutting knives engages slightly into one respective groove of the plurality of grooves disposed opposite thereto so that the ribbon of food is cut into the strips along the transport direction.

21. A testing method for determining an optimization of the apparatus as recited in claim 12 for cutting a ribbon of food, the testing method comprising:
providing the grooved shaft in a direction of the grooved shaft axis with a plurality of zones;
testing each zone of the plurality of zones simultaneously using the ribbon of food; and
determining which dimensions of a zone of the plurality of zones is optimized for an industrial use.

22. A system for longitudinally and transversely cutting a ribbon of food, such as a ribbon of cheese, into pieces, the system comprising:
a longitudinal cutting apparatus toward which the ribbon of food is moved at a transport speed in a transport direction, the longitudinal cutting apparatus comprising, a grooved shaft comprising a grooved shaft axis which is disposed transversely to the transport direction and a plurality of grooves which encircle the grooved shaft in the transport direction of the ribbon of food, the grooved shaft being configured take over the ribbon of food as it is moved toward the grooved shaft, and
a cutting shaft comprising a cutting shaft axis which is disposed transversely to the transport direction and a plurality of cutting knives which encircle the cutting shaft in the transport direction of the ribbon of food;
wherein,
the cutting shaft is disposed opposite to the grooved shaft,
the ribbon of food is guided between the cutting shaft and the grooved shaft, and
one respective cutting knife of the plurality of cutting knives engages slightly into one respective groove of the plurality of grooves disposed opposite thereto so that the ribbon of food is cut into longitudinal strips along the transport direction; and
a transverse cutting unit to which the ribbon of food cut into the longitudinal strips is transferred for a transverse cutting into the pieces, such as into cuboid pieces, the longitudinal cutting apparatus comprising,
a transverse cutting shaft comprising a transverse cutting unit axis and at least one knife blade which is attached to the transverse cutting shaft and which rotates about the transverse cutting unit axis,
wherein,
the transverse cutting unit, via a rotating movement of the at least one knife blade, is configured for transversely cutting the longitudinal strips into the pieces,
wherein,
the transverse cutting unit axis, in a vertical direction, is disposed below the grooved shaft axis and below the cutting shaft axis, and, in a horizontal direction, is disposed between the grooved shaft axis and the cutting shaft axis.
